(19) United States
(12) Patent Application Publication
(10) Pub. No.: US 2008/0201234 A1
(43) Pub. Date: Aug. 21, 2008

(54) LIVE ENTITIES INTERNET STORE SERVICE

(75) Inventors: Pablo Castro, Redmond, WA (US); Alex Anthony Barnett, Redmond, WA (US); D. Britton Johnston, Woodinville, WA (US); Timothy Ian Mallalieu, Sammamish, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/675,933

(22) Filed: Feb. 16, 2007

(51) Int. Cl. G06Q 30/00

(52) U.S. Cl. 705/26

(57) ABSTRACT

The claimed subject matter provides for an online, Internet-class service that can correlate between an application interface utilizing a highly expressive, EDM conceptual format and a data store structured in an efficient, highly scalable storage format. Such a service can include components that map between an EDM schema and a data structure format. Additionally, a query reply can include data presented with a payload format distinct from an EDM query format.

### CROSS-REFERENCE TO RELATED APPLICATIONS

This application is related to co-pending U.S. application Ser. No. ______ (MSFTP1720US), filed , entitled “REST FOR ENTITIES.” The entirety of this application is incorporated herein by reference.

### BACKGROUND

Recent trends in providing software as a service have resulted in several high profile examples of storage as a service. Two well known examples of storage as a service exist today, providing storage for applications such as photo management sites. The photo management sites allow users to upload, manage, link with hypertext markup language (HTML), download and e-mail photographs or other data files. A first set of these storage services provide file system-level programming models for storage of remote data across the Internet. The model has little in the way of strong query capabilities however, providing only a minimal interaction with the database at an application level and falling short of the needs of many database programmers. A second common set of storage as a service provides some basic conceptual modeling capabilities that might bridge the gap between a file-system level programming model and the needs of modern programmers, however the shape of application programming interfaces (APIs) with such storage services have typically taken domain specific forms that can limit the service's capabilities. In general, a significant gap exists between the programming models that modern storage as a service architectures provide and the needs of modern database programmers.

Typically, database programmers require a flexible storage service with a front-end that allows them to create general purpose applications. The file-system level services can offer feature sets that provide for flexibility for an underlying storage implementation. Furthermore, they typically permit a client entity to write, read, and delete an unlimited number of objects up to 5 gigabytes (GB) each. General application services have begun to utilize these services, such as photo sharing sites mentioned above. These services are limited, however, in that they do not provide sophistication for uniform front-end applications. Other storage as a service architectures have adapted more sophisticate front-end services, but have evolved to providing type-specific API's that could potentially limit their overall effectiveness as general storage service architectures. At this point, programmers can still benefit from new approaches yet to be developed for large scale database programming storage services.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in various aspects thereof, provides for a data storage configuration that mediates between a highly expressive conceptual architecture and a highly scalable Internet-type data store architecture. The system can include a mapping component that facilitates information exchange between two or more such data modeling architectures over a representational state transfer (REST) interface. By providing such exchange, a query to a remote Internet-type data store can be sent in a highly expressive conceptual format without exposing structure of the remote data store. Consequently, the data storage configuration can provide a rich data access environment while maintaining scalability of storage resources, such as a server, database or the like.

In accordance with further aspects of the claimed subject matter, a uniform interface is provided over the data storage system, presenting a consistent, model-based mechanism for exposing data in a uniform manner. Supported are query capabilities powerful enough to build general-purpose applications therewith. Such an interface can provide for a mature, consumer-ready application interface (e.g., a web-site or the like), a professional, REST-based API interface (e.g., web-site developers, database designers, etc.), or combinations thereof.

In accord with other aspects of the claimed subject matter, an online, Internet-scale system allowing users to define schemas in terms of an entity data model (EDM) is disclosed. The system further manages the manner in which information is stored at a remote data store, independent from an EDM schema created by a user. Such a system can additionally be deployed within a large, private intranet for private, rich store and application services.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 illustrates a system that maps a stateless, uniform REST interface with a highly scalable Internet-type data store in accord with an aspect of the claimed subject matter.

FIG. 2 depicts an expressive query structure for building general purpose applications in conjunction with a highly scalable Internet-type data store in accord with various aspects of the disclosure.

FIG. 3 depicts a system that maps between a highly expressive, EDM modeling schema and a highly scalable data store model in accord with aspects of the subject disclosure.

FIG. 4 illustrates an exemplary service agreement, providing varying levels of data store support in conjunction with an aspect of the subject innovation.

FIG. 5 depicts a sample methodology for providing a highly expressive modeling environment while maintaining scalability of Internet-type data stores in accord with aspects of the claimed subject matter.

FIG. 6 illustrates an exemplary methodology 600 for managing an interface between a web-type data store and a EDM application modeling environment in accord with various aspects described herein.

FIG. 7 depicts a sample methodology for providing a commercially available service platform in accord with aspects of the subject innovation.

FIG. 8 illustrates an example networking environment sufficient to support an interface between a highly expressive, application conceptual model and a highly scalable data store model.

FIG. 9 depicts an exemplary computing environment in accord with aspects of the subject innovation.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, “interface”, “entity data model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. As another example, an interface can include I/O components as well as associated processor, application, and/or API components, and can be as simple as a command line or a more complex Integrated Development Environment (IDE).

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

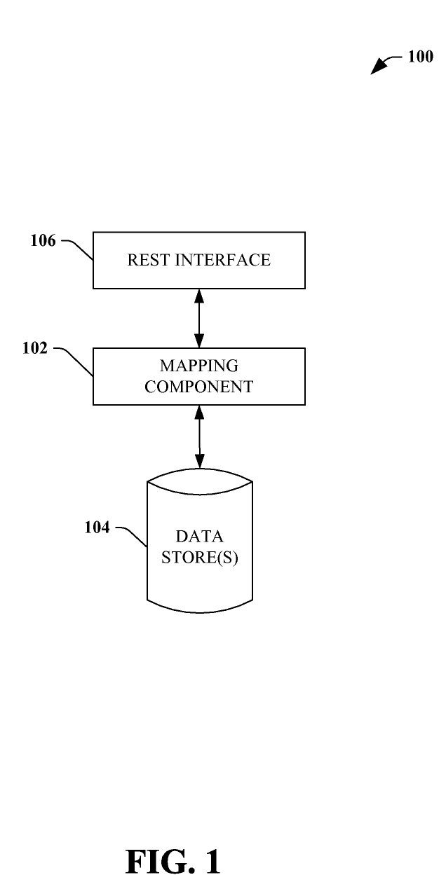

With reference now to FIG. 1, a system 100 is illustrated that maps a stateless, uniform REST interface to a highly scalable Internet-type data store in accord with an aspect of the claimed subject matter. Mapping component 102 can be a computer-related entity capable of translating between a highly expressive, conceptual application environment and a data storage environment. It should be appreciated that mapping component 102 could be a subset of a data store, a client application or component, a separate intermediary component, or combinations thereof. The data storage environment can be any suitable storage schema including relational schema (e.g., SQL database server), or a highly scalable, Internet-class schema. The conceptual application environment can be any suitable environment for modeling data in a highly expressive format, without having to specify how data is structured in a storage environment.

As an example to provide context for system 100, but not to limit system 100, a conceptual data modeling environment can express data in terms of a real-world entity, such as a person, business, or class of persons or businesses. A consumer could be a real-world entity, for instance, and such consumer could be a human being, a business, a government, etc. Therefore, mapping component 102 can interface between a data storage environment and an entity data model (EDM) programming environment (e.g., similar to a client views engine exhibited in a .NET-brand Framework). Furthermore, mapping component 102 can facilitate information exchange between an EDM model environment, and a highly-scalable Internet-class storage structure (discussed infra).

The EDM programming environment can be a formal way of modeling data that explicitly defining an entity, such as the real-world consumer specified above. In addition, the EDM can specify a particular instance of an entity, (an entity instance can be referred to as an Entity), and associate that instance with an entity type, and group it with other specific instances within an entity set. This structure utilized by the EDM allows for a highly expressive data modeling environment independent of the data storage structure. Entities (instances) therefore can have a particular relationship with Entity types, and can have relationships with other aspects of the EDM as well.

Entity types can have properties that can distinguish between entity types or instances of entities associated with a type. Properties can therefore be utilized to filter one set of EDM data from another set of EDM data. Examples of properties can include a ‘name’, ‘address’, ‘phone number’, ‘e-mail’ etc., associated with an entity type or instance. In most real-world applications, entities are related to other entities. The EDM can incorporate this concept via the notion of relationships, which can express an association between one entity and another.

System 100 can provide a bridge between an application utilizing a conceptual model, such as the EDM, and a database using a structured storage model. Typically, computer database applications provide some interface and structure with which to organize and present data related to a particular context. As an example, to help define a potential market for a particular new product a marketing application may access data pertaining to cost, demand, and purchasing histories related to similar products. To do so, such application can access a compilation of data, e.g., stored within a relational database, a structure query language (SQL) database, etc., and organize that data in a manner that represents the desired cost, demand and purchase history information, for instance. Such database query languages might specify a row, column and/or name of a particular ‘data block’ within a virtual spreadsheet where particular data might be stored. Although such a structure can be efficient for storing data, it is not always efficient for representing data in an application.

In contrast, EDM can create a tiered architecture that enables description of data at a higher level of abstraction. For instance, an EDM approach can be less focused on the structural details that have to do with systems and more focused on the structural and semantic characteristics of the data itself, as seen by a data modeler (e.g., web-site, database, API developers, etc.) A conceptual schema (e.g., based on an EDM schema) for identifying and accessing data can be much more efficient when writing database applications. For example, in regard to the previous marketing concept, assume data indicates that a new ‘toothbrush’ (entity instance, a product in this case) can ‘support’ (relationship) a ‘$100 million’ market (entity instance, or navigational property). It can be much more efficient for an application programmer to query a database in terms of these entities upon which an application is focused rather than a row or column of a database. Mapping component 102 can allow a programmer to do just that, by translating between a highly expressive data modeling environment and a data storage environment.

Mapping component 102 can incorporate more sophisticated EDM architectures in addition to those specified supra. One example is an incorporation of action-type entities, in addition to relationship entities. Such actions can be expressed in EDM terms (e.g., to refer to entities in EDM schemas as Action types, Action instances, and/or Action sets), and can be mapped to actual implementations within data stores. When using actions, a situation such as “start marketing campaign” could define a parameter related to a customer action. Such an action could be invoked with a URI similar to a manner in which relationships are invoked (discussed infra). Another example is a general purpose synchronization architecture where applications could not only access information across a web-scale network, such as the Internet, but also to synchronize it with local stores such as SQL servers. Such synchronization could provide, in effect, an offline operation mode between databases. In addition to traditional client-server replication, peer-to-peer replication can be supported, enabling the creation of applications with multiple peers carrying EDM stores with entities, forming a mesh-store that is convergent as storage configurations synchronize changes over time.

Data store(s) 104 can be one or more physical or virtual storage devices having data organized in accord with an efficient storage architecture. Such a storage architecture can include a relational schema or can include an Internet-class schema that enables a highly scalable and manageable environment for a vast, web-type network such as the Internet. System 100 also can incorporate a representational state transfer (REST) interface 106, providing a stateless and uniform system for exchanging information to and from data store(s) 104.

In general, the REST transfer model incorporated into system 100 can include several characteristics that have proven effective with a large-scale networking environment. Examples include a stateless component interaction, a layered component architecture, client and server-side cache, and a uniform component interface. Stateless interaction specifies that each query and/or response must contain all information necessary to effectuate information transfer related thereto. Thus, components are not required to keep track of prior interactions with other components, freeing up memory and processing resources for additional interactions. Although such a system can increase repetitive requests, client and server-side cache can help to alleviate resource demands resulting from such repetitive requests by storing prior transmission by a component, at that component. Additionally, the layered component architecture places an upper bound on system complexity and promotes component independence, whereas the uniform component interface ideal for large-grain hypermedia data transfer (e.g., large data files such as video, audio, etc.) typical for Internet or large intranet applications. It should be appreciated that REST interface 106 can include some or all of these characteristics, as well as additional characteristics facilitating data transfer in a large-scale networking environment. By joining REST interface 106 with mapping component 102, and data store(s) 104, system 100 can provide a desirable, EDM programming interface to one or more data stores, while providing a high degree of efficiency and scalability at those data stores.

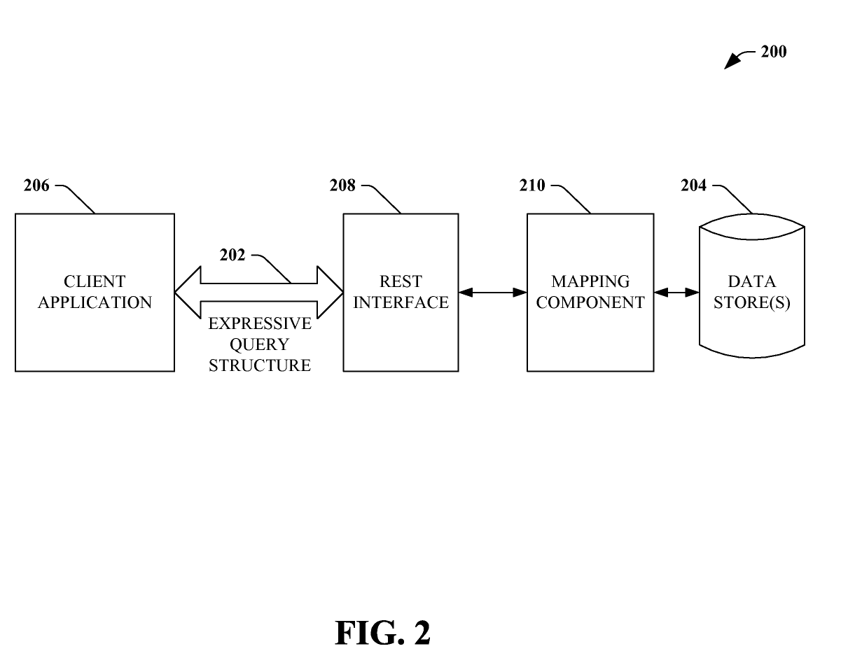

With reference to FIG. 2, a system is illustrated that utilizes an expressive query structure 202 in conjunction with a data store 204 (e.g., a relational model or highly scalable Internet-type model) enabling intuitive conceptual interaction therewith. System 200 can include development tools in conjunction with REST interface 206 to help easily build an interface to applications (e.g., tools such as active server pages [ASP] and subsequent technologies and other technologies associated with a .NET-brand Framework). Client application 206 can be any suitable framework, e.g., an asynchronous java script and extensible markup language (XML) termed AJAX, which can utilize a REST interface 208 over the Internet or a large intranet to access data store(s) 204. System 200 can extend client application 206 (e.g., AJAX and the like) by interfacing such client with mapping component 210, giving direct access to EDM stores (e.g., data store(s) 204 mapped to an EDM format by mapping component 210, as discussed supra) via REST interface 208. Consequently, a user (e.g., web developer etc.) does not need to create separate web services for each interaction between client application 206 and data store(s) 204 (e.g., creation, retrieval, update, delete (CRUD) operations).

Data store(s) 204 can be mapped by mapping component 210 to EDM entities, which can then be exposed as resources with stable URIs through REST interface 208. Such URIs will then reflect the resource stores on data store(s) 204, but described by an EDM schema. Consequently, expressive query structure 202 can take the form of a web-style transfer protocol (e.g., HTTP protocol, and the like) structured in the form of a URI namespace. Such a structure can define resources on data store(s) 204 according to an EDM schema. Expressive query structure 202, therefore, can provide a means of interacting with relational or highly scalable Internet-class databases utilizing a highly expressive, familiar structure (e.g., URI query structure). One example URI-based format for expressive query structure 202 is:

<base URI>/<entity container refx
file>[/<entityset>[/<entitykey>[/<association navigation
property>]]]?<options>

for example

http://entities.live.com/refx/northwind/refx/Customers/ALFKI or, as an alternative example,

http://entities.live.com/refx/northwind/refx/Customers/[ALFKI].

Such an alternative with square brackets can allow for data lookup functions utilizing non-key fields, for example:
http://entities.live.com/refx/northwind.refx/Customers[CompanyName=“Company_One”].
   The “base URI” can point to a web server/directory that can host an Entity environment (e.g., an Entity Framework) and REST extensions. A “refx file” (discussed in more detail infra) represents a connection to a store/container (e.g., data store(s) 204); an entity set, entity key, and navigation property are regular EDM constructs. Options can include representations of data, and will be discussed in more detail infra.

System 200 can provide a uniform interface for customizing applications, whether for simple, or complex, logic operations. Some client applications 206 merely reference data for most operations (e.g., read-only applications), while other applications interact utilizing more intensive business logic operations (e.g., data creation, modification, analysis, compilation etc.) In the former case, developers often create web service entry points or customized applications that act as gateways to the database, with no behaviors or policies attached to them. Other applications are policy intensive and assign particular policies and behaviors on the server-side. System 200 can help to unify these applications. First, it obviates the requirement for simple, independent gateways by way of the mapping component 210 and REST interface 208, which can provide direct transport to data store(s) 204 when no special policy or behavior is attached. For a case where more business logic is required, system 200 can provide a simple starting point that can be customized iteratively. Various mechanisms can exist for attaching behaviors and describing policies around data store(s) 204 exposed as EDM stores (e.g., by mapping component 210, as discussed supra).

Expressive query structure 202 (e.g., URI based queries), discussed above, can use a ‘refx’ file that acts as a descriptor of an exposed EDM schema. Such files can point at least to a portion of mapping component 206 (e.g., to a database and to metadata files associated therewith) that can describe an EDM schema to storage schema mapping structure. Additionally, expressive query structure 202 can control aspects of that data that is exposed. For example, a user can control whether each entity-set (e.g., as characterized through mapping component 206) of data store(s) 204 is accessible, read-only, or read-write.

System 200 can also provide a mechanism to control database behaviors by way of expressive query structure 202. Such behaviors (e.g., security checks that can analyze and reject or flag suspect data) can be associated with entity types referred to within expressive query structure 202. Specifically, access can be provided to an actual entity/query as an entity framework object (e.g., .NET-brand object), and an “ObjectContext” item representing an entry point to data store(s) 204 in accord with an EDM structure. As an example of a behavior, below is a C# function that is activated when a ‘product’ entity instance is written to a ‘products’ entity-set. The function can check other portions of data store(s) 204, for instance, and then can abort a ‘product’ creation or update operation and flag such operation:

```
    Public static void ReceiveProduct(Northwind ctx, Product product) {
        // get the category for this product
        product.CategoryRef.Load( );
        Category category = product.Category;
        // get the products that have a price outside of
        // the +/− 10% range
        var q = from p in category.Products.Source
            where p.UnitPrice > (products.UnitPrice * 1.1m) ||
                p.UnitPrice < (product.UnitPrice * 0.9m)
            select p;
        // see if we got any matches, and if so record the names
        string products = “”;
        foreach(NorthwindLib.Product p in q) {
            products += p.ProductName + “; “;
        }
        // raise an error if needed
        if(products != “ ”) throw new Exception(
            “Product prices can't vary more than +/− 10% within a
category,” +
            “the following products are outside of that range: “ +
products)
```

It should be noted that the approach represented in this example C# code is a procedural approach and can be implemented in conjunction with system 200 where data store(s) 204 represent relational data stores or SQL data stores on an intranet (e.g., large corporate network environment). For internet-scale applications, a declarative policy example can be utilized.

System 200 also supports additional methods of querying via expressive query structure 202, aside from the URI model describe above. While developers can typically utilize URI's to discover what is available in particular data stores, application users will generally query and/or search using various filters or criteria. Consequently, expressive query structure 202 can also support a filter and/or criteria based search through client application 206. One example of such criteria-based searching are resource description framework (RDF) query languages RQL and SPARQL. Such RDF query languages are very broad in terms of expressivity and are widely accepted in industry.

Filter-based search queries can also include an EDM-structured dialect of the SQL language, called EntitySQL. Expressive query structure 202 can support ‘query fragments’ specified by the eSQL language to perform filter-based searches. As a further example, a query of strings within a URI can point to an entity-set called ‘customers’ and only return instances of ‘customers’ that have a particular property associated therewith. For instance, a property ‘country’ of Argentina filter can look as follows:
http://entities.live.com/refx/northwind/refx/Customers?where=it.Country=Arg entina
   Expressive query structure 202 can further support e-SQL fragment constructs as well. For instance, EDM navigation properties can be used for distinction between entity relationships. More specifically, an example that requests ‘customer’ instances that have more than 10 orders can be “COUNT(it.SalesOrders)>10”. Another specific example of structured query language 202 can be Xpath, a simple well-known query language that works well for querying graphs (e.g., utilized in querying EDM schemas with relationships). In addition, support for using POST requests for queries where the query is the payload (e.g., the message of the query, instead of information added thereto). Expressive query structure 202 can therefore avoid problems associated with embedding a query language into a URI.

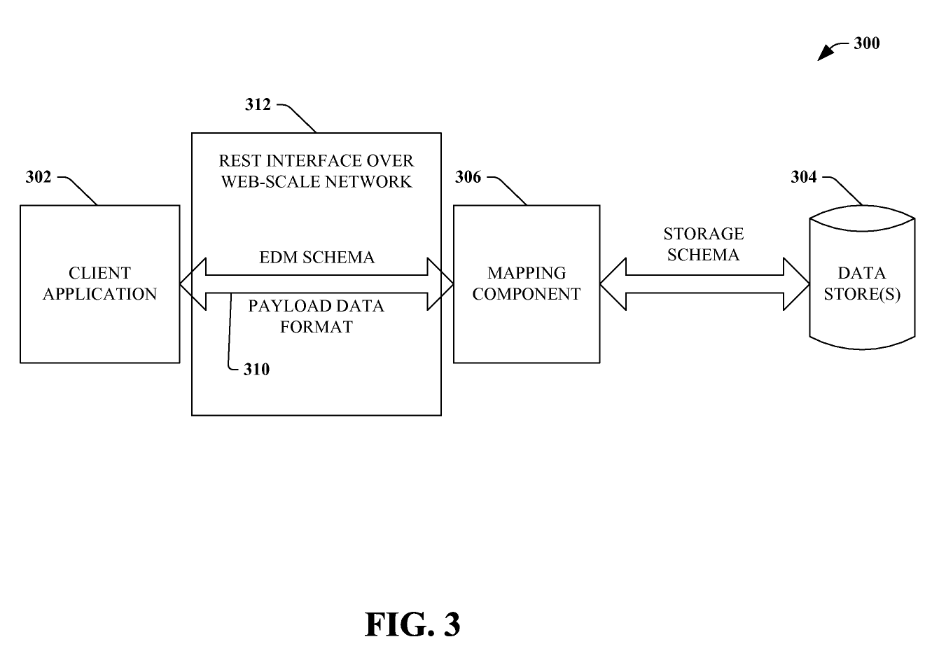

Referring now to FIG. 3, depicts a system 300 that provides an interface between a client application 304 and data store 306 wherein data can be transmitted in a particular data payload format in accord with aspects of the subject disclosure. Mapping component 302 can provide an interface between a client application 304 utilizing an EDM schema and a data store(s) 306 utilizing a storage schema as discussed supra. Data store(s) 306 can have a structure defined by relational schema (e.g., SQL server) that can be utilized, for instance, within a large intranet-type network (e.g., corporate network) or a special, highly scalable Internet-class storage schema, which can be used on the Internet, for instance. Client application 206 can utilize an expressive conceptual format for modeling data, and a related conceptual format for interacting with a database (e.g., EDM format as discussed above in regard to expressive query structure 202 of FIG. 2). REST interface 308 provides a platform by which client application and data store(s) can communicate over a large, remote network, and can support schemas such as EDM and the like. However, REST generally does not specify particular formats with which data is presented, other mechanisms supply such data format.

System 300 can incorporate a payload format, or data representation format, as represented by reference numeral 310, to specify data transmitted between client application 302 and data store(s) 304. Examples include plain old XML (POX), rich site summary (RSS), java script notation (JSON), resource description framework (RDF), ATOM, and the like. Each data payload format can have a different format by which data is displayed, though generally they are similar. Examples of POX, JSON, and RDF are included below.

As an example, assume a particular entity instance having a key of ‘ALFKI’ belonging to a ‘customer’ entity type. A JSON structured reply for an EDM query specifying as such can appear substantially similar to the following:

```
http://entities.live.com/refx/northwind.refx/Customers/
ALFKI?responseType=text/json
    {
        ‘_base’: ‘http://entities.live.com/refx/northwind.refx’,
        ‘_about’: ‘Customers/ALFKI’,
        ‘CustomerID’: ‘ALFKI’,
        ‘CompanyName’: ‘Alfreds Futterkiste’,
        ‘ContactName’: ‘Maria Anders’,
        ‘City’: ‘Berlin’
        ‘Country’: ‘Germany’
        ‘SalesOrders’: { ‘_resource’: ‘Customers/ALFKI/SalesOrders’
}
    };
```

Note that client application 302 need only specify a query in an expressive, EDM format via REST interface 312. Mapping component can automatically manage the actual way in which information is stored at data store(s) 304, in a schema independent from the schema utilized by client application 302 (e.g., a consumer or application customer, etc.) The same query in POX format could appear substantially similar to the following:

```
<Customer>
    <CustomerID>ALFKI</CustomerID>
    <CompanyName>Alfreds Futterkiste</CompanyName>
    <ContactName>Maria Anders</ContactName>
    <City>Berlin</City>
    <Country>Germany</Country>
    <SalesOrders href=”Customers/ALFKI/SalesOrders” />
</Customer>
```

and in RDF format:

```
    <rdf:RDF xml:base=http://entities.live.com/refx/northwind.rfx
                Xmlns:rdf=”http://www.w3.org/1999/02/22-rdf-syntax-ns#>
            <Customer rdf:about=”Customers/ALFKI”>
                    <CustomerID>ALFKI</CustomerID>
                    (3.)<CompanyName>Alfreds
Futterkiste</CompanyName>
                    (4.)<ContactName>Maria Anders</ContactName>
                    (5.)<City>Berlin</City>
                    (6.)<Country>Germany</Country>
                    (7.)<SalesOrders
rdf:resource=”Customers/ALFKI/SalesOrders”/>
            </Customer)
        </rdf:RDF>
```

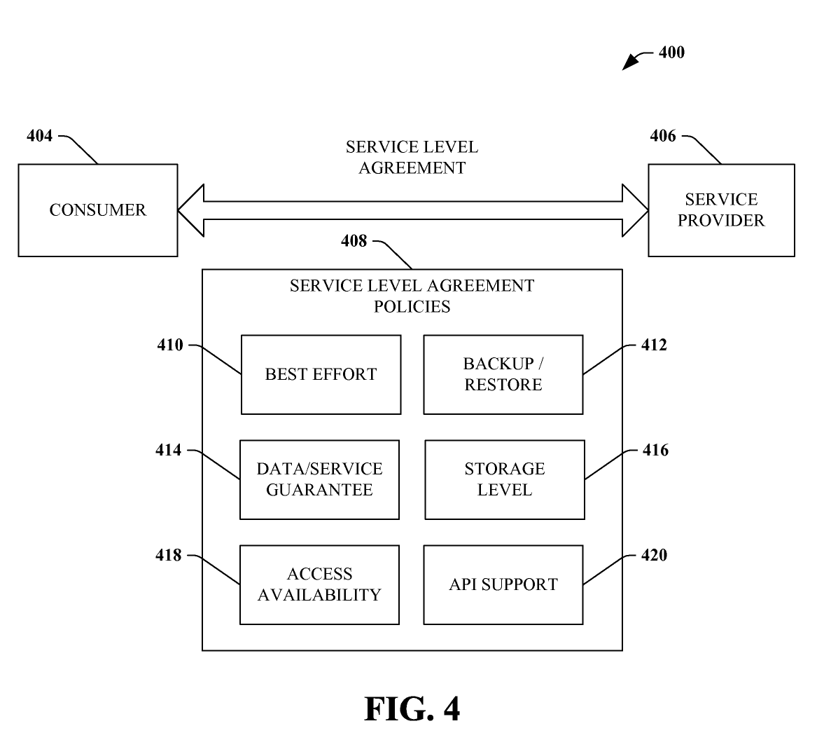

Referring to FIG. 4, an illustration of a sample service level agreement 400 is provided between a consumer 402 and a service provider 404, and policies that can distinguish between agreements (e.g., 410 through 420). Service level agreement 400 provides for a data storage service that can, among other things, correlate between an expressive query schema and a data store schema (e.g., a relational schema, highly scalable Internet-type data store schema, or other database storage schema for instance). Such a service can automatically manage the data store schema independently of the expressive schema (e.g., EDM schema and the like) utilized by a client-system. Furthermore, the storage service can support various payload representation formats, as discussed above. In addition, the mapping service can be made available on the Internet or large intra-networks (e.g., large corporate intranets).

Also depicted are sample service level agreement policies with which to structure a service level agreement. One policy can be a best effort 410 policy, provided at minimal cost, for example. Best effort policy can provide a basis level of service, e.g. a mapping service that correlates between an expressive query schema and a data store schema, but that provides no specific quality assurances (e.g., support, backup, recovery, availability, and the like). As an example to illustrate, best effort policy 410 can be a license between consumer 404 and data mapping service provider 406 allowing consumer 404 utilize the data mapping service, for instance at a nominal fee and at their own risk, with no other obligation on the part of data mapping service provider 406. Backup/Restore policy 412 can be a service further to that provided by best effort policy 410, including backup and restore operations to protect data uploaded by consumer 404. Service provider 406 can create a copy of data uploaded by consumer 404 and restore it should a problem occur. Data/Service guarantee policy 414 can, in addition or lieu of backup restore policy 412, provide a more robust backup and restore scenario. Such a policy can, for instance, backup and restore data and also guarantee such data up to a certain value provided in a service level agreement 402.

Service level agreement can provide numerous additional services related to data store, in addition to backup and restoration services described above. For example, a service level agreement could be based on a particular storage level policy 416, establishing a storage size (e.g., in mega-bytes, giga-bytes, tera-bytes, and the like) at a particular rate. Also, an access availability policy 418 can, for instance, provide a guarantee that data can be accessible, at a particular quality or with a particular server-side access speed for example, worldwide, or in specified portions of the world. As an example, if a United States-based consumer 402 has data stored for a web-site and desires such data to be available for an affiliate in Japan, access availability policy 418 can specify standards for doing so. As another example, an application programming interface (API) support policy 420 can be specified that provides use of established applications or development tools for creating applications over an interface (e.g., a REST interface). It should be appreciated that the examples provided in FIG. 4 are to create a context for various service level agreements related to aspects of the subject innovation, and should not be construed so as to limit other contexts.

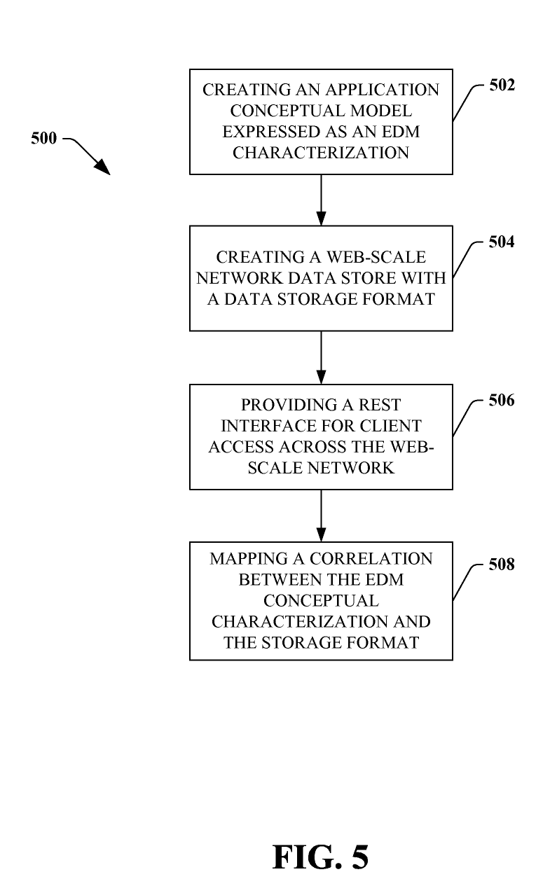

Referring now to FIG. 5, an example methodology 500 is depicted for providing a highly expressive modeling environment while maintaining scalability of Internet-type data stores in accord with aspects of the claimed subject matter. At 502, an application conceptual model is created or obtained from a repository, expressed as an EDM characterization. The conceptual model can be domain-specific and have any suitable form available through the EDM. Examples include various defined entities representing a virtual or real-world entity (e.g., practically any noun, such as a person, place, object, business, position or office, etc.) as entity instances, types, and sets. Various defined relationships representing associations, properties, or inheritances occurring between entities (e.g., peer-to-peer associations, parent-child inheritance models, and the like) also as relationship instances, types and sets. Relationships and entities can be mapped to a particular resource store on a data store, as specified by the application conceptual model expressed as an EDM characterization, for instance. At 504, a web-scale network data store is created for the application conceptual model in a data storage format. In addition, the data storage format can be any suitable format for structuring data on a data store (e.g., an SQL database in a corporate network, a highly scalable Internet-class storage format for an Internet-class database, etc.)

A REST interface can be provided over a web-scale network data store, exposing data within such data store to other components on the network (e.g., client components). The REST interface can allow for a stateless and uniform interaction with a data store, and can facilitate REST-style query structures utilizing the EDM characterization (e.g., with an EDM URI structure). An EDM query can provide a highly expressive format in which to perform basic CRUD operations on a data store. At 508, a correlation is mapped between the EDM conceptual characterization and the data storage format. Such correlation facilitates managing the data store in a data storage format independently from EDM queries over the REST interface. Consequently, methodology 500 provides a highly expressive, concept-oriented interface environment (e.g., for programming, application use, and the like) while maintaining a data storage format optimized for scalability and efficiency.

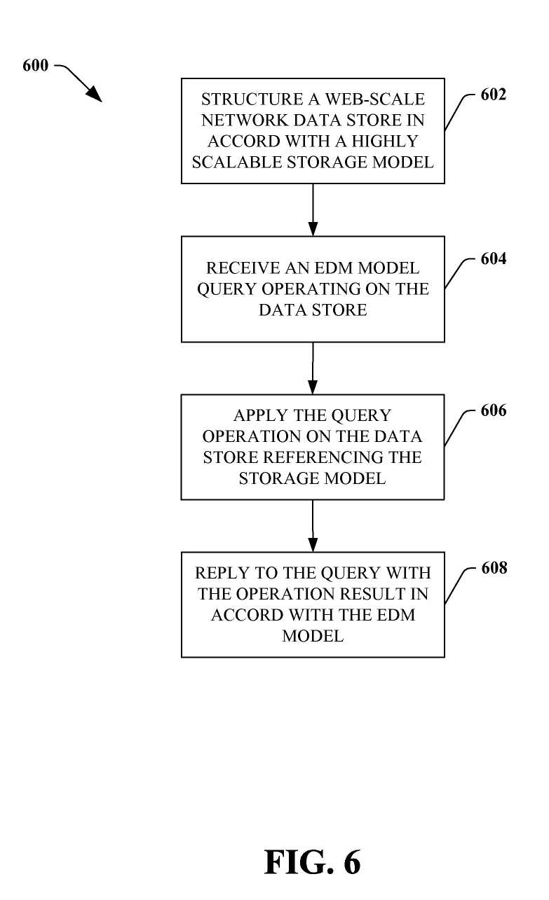

Referring now to FIG. 6, an exemplary methodology 600 is depicted for managing an interface between a web-type data store and an EDM application modeling environment in accord with various aspects described herein. At 602, a web-scale network data store is structured in accord with a highly scalable storage model. As disclosed supra, the storage model can be, e.g., for an Internet-class data store, deployed on the Internet, that is capable of storing large quantities of data and handling very large query volume. Alternatively, the storage model can be for an SQL-class database deployed in a corporate network environment. At 604, a query structured in accord with an EDM model is received at the data store. The query can, for instance, specify a particular domain (e.g., for example an entity container) an entity type, an entity instance (e.g., by way of an entity key), navigation property, filter (e.g., similar to the e-SQL filters described supra), relationship type, relationship set, relationship instance, etc. It should be appreciated that an EDM query, as disclosed at reference number 604, can be utilized to build general purpose database applications in a developer/consumer-friendly manner, by way of an interface to the data store (e.g., a REST interface).

At 606, an operation specified by the query is applied on the data store, with reference to the data storage model. In such a manner, an application and/or query schema can be formulated in a particular format (e.g., a highly expressive, EDM conceptual format) independent of a schema used to manage information on the data store. At 608, the query is replied to with the operation result, in accord with the EDM model. For example, if a query operation required uploading data to a data store, an indication can be returned at reference number 608 that the operation was successful, not successful, etc. As a further example, if a query operation requested data be retrieved from a data store, then the reply at reference number 608 will contain such data. Furthermore, data specified by the reply can have a distinct format, such as a payload format, as described supra.

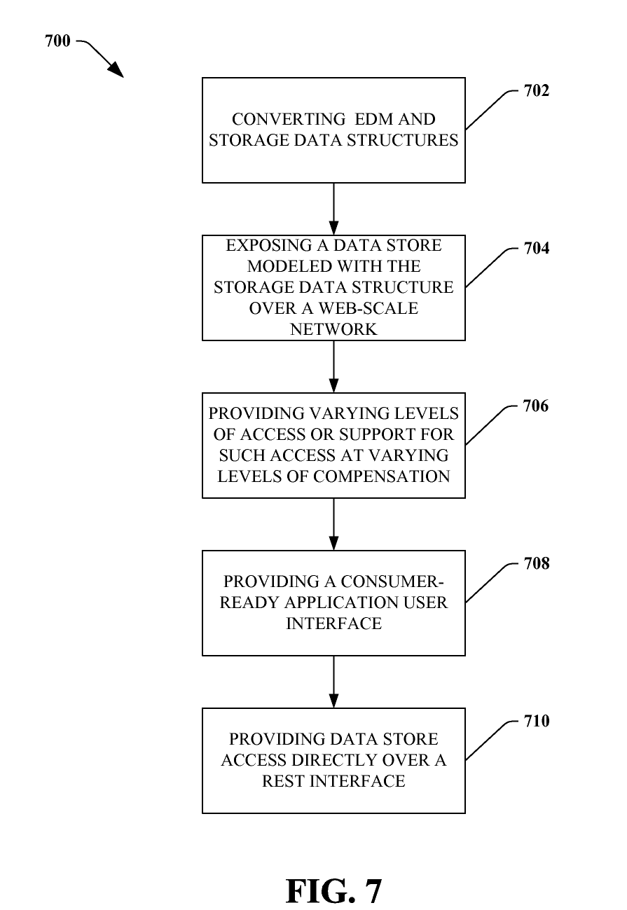

Referring now to FIG. 7, a sample methodology 700 for providing a commercially available service platform in accord with aspects of the subject innovation is depicted. At 702, a conversion is performed between an EDM data structure and storage modeling structures. The conversion can take place over, for example, a REST interface between a networked server system and a client system. Alternatively, the conversion can take place at a system affiliated with a data store device, with a client device, or with an intermediary device. Moreover, the network can be a web-scale network, such as the Internet or a corporate intranet. Additionally, the storage data modeling structure can be a highly scalable storage modeling structure (e.g., utilized with an Internet-class data store). At 704, a data store modeled with the storage data modeling structure is exposed over a web-scale network (e.g., by way of a REST interface and/or the like). At 706, levels of access and/or support for such access are provided at varying levels of compensation. Support and/or access levels can include, for example, data backup and restoration services, guarantees against data loss, regional, national, or worldwide availability to data at a particular level of quality, etc. Levels can be specified to fit needs of individual consumers, small business, large enterprises, governments, and the like. Additionally, levels of compensation for the support and/or access can correspond to at least the levels of access and/or support themselves. At 708, a consumer-ready application user interface can be provided. Additionally, at 710, direct access to the data store can be provided over a REST-style API interface.

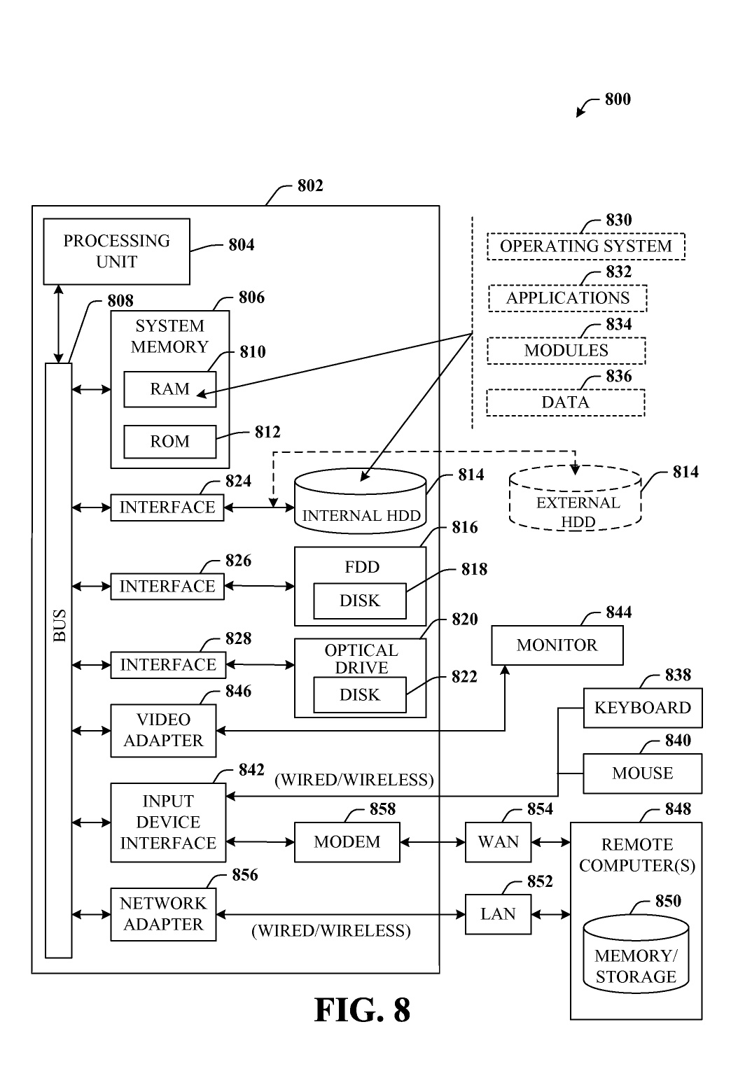

Referring now to FIG. 8, there is illustrated a block diagram of an exemplary computer system operable to execute the disclosed architecture. In order to provide additional context for various aspects of the subject invention, FIG. 8 and the following discussion are intended to provide a brief, general description of a suitable computing environment 800 in which the various aspects of the invention can be implemented. Additionally, while the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 8, the exemplary environment 800 for implementing various aspects of the invention includes a computer 802, the computer 802 including a processing unit 804, a system memory 806 and a system bus 808. The system bus 808 couples to system components including, but not limited to, the system memory 806 to the processing unit 804. The processing unit 804 can be any of various commercially available processors. Dual microprocessors and other multi-processor architectures may also be employed as the processing unit 804.

The system bus 808 can be any of several types of bus structure that may further interconnect to a memory bus (with or without a memory controller), a peripheral bus, and a local bus using any of a variety of commercially available bus architectures. The system memory 806 includes read-only memory (ROM) 810 and random access memory (RAM) 812. A basic input/output system (BIOS) is stored in a non-volatile memory 810 such as ROM, EPROM, EEPROM, which BIOS contains the basic routines that help to transfer information between elements within the computer 802, such as during start-up. The RAM 812 can also include a high-speed RAM such as static RAM for caching data.

The computer 802 further includes an internal hard disk drive (HDD) 814 (e.g., EIDE, SATA), which internal hard disk drive 814 may also be configured for external use in a suitable chassis (not shown), a magnetic floppy disk drive (FDD) 816, (e.g., to read from or write to a removable diskette 818) and an optical disk drive 820, (e.g., reading a CD-ROM disk 822 or, to read from or write to other high capacity optical media such as the DVD). The hard disk drive 814, magnetic disk drive 816 and optical disk drive 820 can be connected to the system bus 808 by a hard disk drive interface 824, a magnetic disk drive interface 826 and an optical drive interface 828, respectively. The interface 824 for external drive implementations includes at least one or both of Universal Serial Bus (USB) and IEEE1394 interface technologies. Other external drive connection technologies are within contemplation of the subject invention.

The drives and their associated computer-readable media provide nonvolatile storage of data, data structures, computer-executable instructions, and so forth. For the computer 802, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules can be stored in the drives and RAM 812, including an operating system 830, one or more application programs 832, other program modules 834 and program data 836. All or portions of the operating system, applications, modules, and/or data can also be cached in the RAM 812. It is appreciated that the invention can be implemented with various commercially available operating systems or combinations of operating systems.

A user can enter commands and information into the computer 802 through one or more wired/wireless input devices, e.g., a keyboard 838 and a pointing device, such as a mouse 840. Other input devices (not shown) may include a microphone, an IR remote control, a joystick, a game pad, a stylus pen, touch screen, or the like. These and other input devices are often connected to the processing unit 804 through an input device interface 842 that is coupled to the system bus 808, but can be connected by other interfaces, such as a parallel port, an IEEE1394 serial port, a game port, a USB port, an IR interface, etc.

A monitor 844 or other type of display device is also connected to the system bus 808 via an interface, such as a video adapter 846. In addition to the monitor 844, a computer typically includes other peripheral output devices (not shown), such as speakers, printers, etc.

The computer 802 may operate in a networked environment using logical connections via wired and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wired/wireless connectivity to a local area network (LAN) 852 and/or larger networks, e.g., a wide area network (WAN) 854. Such LAN and WAN networking environments are commonplace in offices and companies, and facilitate enterprise-wide computer networks, such as intranets, all of which may connect to a global communications network, e.g., the Internet.

When used in a LAN networking environment, the computer 802 is connected to the local network 852 through a wired and/or wireless communication network interface or adapter 856. The adapter 856 may facilitate wired or wireless communication to the LAN 852, which may also include a wireless access point disposed thereon for communicating with the wireless adapter 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wired or wireless device, is connected to the system bus 808 via the serial port interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11 (a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 9BaseT wired Ethernet networks used in many offices.

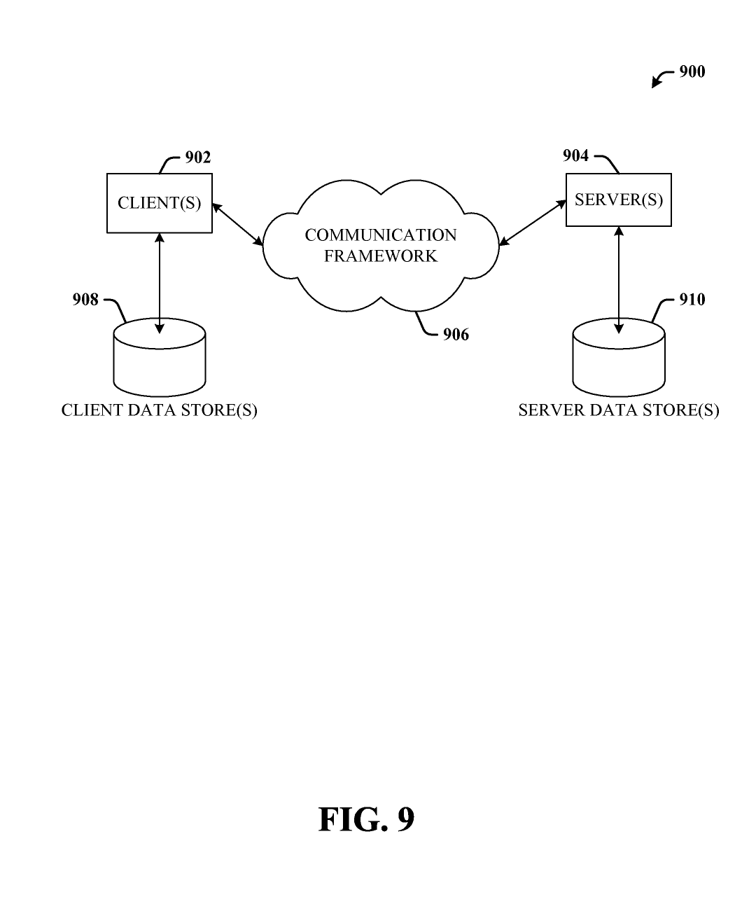

Referring now to FIG. 9, there is illustrated a schematic block diagram of an exemplary computer compilation system operable to execute the disclosed architecture. The system 900 includes one or more client(s) 902. The client(s) 902 can be hardware and/or software (e.g., threads, processes, computing devices). The client(s) 902 can house cookie(s) and/or associated contextual information by employing the invention, for example.

The system 900 also includes one or more server(s) 904. The server(s) 904 can also be hardware and/or software (e.g., threads, processes, computing devices). The servers 904 can house threads to perform transformations by employing the invention, for example. One possible communication between a client 902 and a server 904 can be in the form of a data packet adapted to be transmitted between two or more computer processes. The data packet may include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that provides network data storage as a service, comprising:
a data store that includes a storage model that defines a structure of data storage;
a REST interface that can facilitate information exchange to and from the data store; and
a mapping component that can correlate between the data storage model and an EDM conceptual model, where the data storage model and the EDM conceptual model are different.

2. The system of claim 1, the data storage model includes an efficient storage schema.

3. The system of claim 1, the EDM conceptual model includes a rich, highly expressive EDM schema.

4. The system of claim 1, the data store is an Internet data store, the storage model is an Internet-scale database storage model.

5. The system of claim 1, the data store is an Intranet data store, the storage model is a structured query language (SQL) database storage model.

6. The system of claim 1, further comprising a client application that can interact with the data store by way of the REST interface and mapping component.

7. The system of claim 6, the client application interacts with the data store according to the EDM conceptual model by way of the REST interface.

8. The system of claim 6, the data store interacts with the client application according to the storage model by way of the REST interface.

9. A method for providing a commercially available database service platform, comprising:
converting between an EDM data structure and a highly scalable storage modeling structure;
exposing a data store modeled with the highly scalable data structure over a web-scale network by way of a REST interface; and
providing varying levels of access, or support for such access, or both, at levels of compensation that correspond at least to the levels of access, support, or both.

10. The method of claim 9, further comprising providing a consumer-ready application user-interface to access the data store, or a direct access REST-style API interface to access the data store, or both.

11. A method for providing network data storage as a service comprising:
receiving an application conceptual model expressed by way of an entity data model (EDM) characterization;
mapping a correlation between the EDM characterization and a storage characterization format; and
providing a representational state transfer (REST) interface enabling stateless, uniform interaction with data in a data store.

12. The system of claim 11, further comprising providing a web-scale network data store for storage of data related to the application conceptual model, the data store structured according to the storage characterization format.

13. The method of claim 11 further comprising transmitting data from the store in response to a query.

14. The method of claim 12, the entities are in a form useful to an application associated with the application conceptual model.

15. The method of claim 11, the EDM specifies at least one of an Entity type, Entity instance, or an Entity set, a Relationship type, Relationship instance, or Relationship set, or an Action type, Action instance, or Action set, or a combination thereof.

16. The method of claim 12, further comprising applying an EDM schema, defined by the EDM characterization, to interaction with data in the data store.

17. The method of claim 15, further comprising defining a storage schema for the data store distinct from the EDM schema applied to the interaction with data in the data store.

18. The method of claim 16, further comprising mapping a correlation between the EDM schema applied to the interaction with data in the data store and the storage schema for the data store.

19. The method of claim 16, the storage schema is an EDM schema, distinct from the EDM schema defined by the EDM characterization.

20. The method of claim 12, the data transmitted from the store is characterized by a data representation format that can include java script object notation (JSON), resource description framework (RDF), or plain old extensible mark-up language (POX), or a combination thereof.
